(19) United States
(12) Patent Application Publication
(10) Pub. No.: US 2015/0310554 A1
(43) Pub. Date: Oct. 29, 2015

(54) System And Method For A Computer Implemented Retirement Plan

(71) Applicant: Thomas L. Totten, Indianapolis, IN (US)

(72) Inventor: Thomas L. Totten, Indianapolis, IN (US)

(21) Appl. No.: 14/264,890

(22) Filed: Apr. 29, 2014

(51) Int. Cl. G06Q 40/06

(52) U.S. Cl. CPC G06Q 40/06

(57) ABSTRACT

A system and method for a computer implemented retirement plan directing inputs to defined benefit and defined contribution components whereby an employee or beneficiary is provided a single income stream, wherein comprising time phase shifted or stacked payout of the defined contribution balance from retirement to a predefined date, followed by payments by the defined benefit component from the predefined date until the death of the employee or beneficiary.

### FIELD OF THE INVENTION

The present invention relates generally to a computer implemented retirement system and method for providing a single retirement income stream to a beneficiary, and more specifically to providing and implementing a defined contribution (DC) plan, which is meant to be consumed over a given number of years, and stacking a defined benefit (DB) plan with the DC plan that continues retirement payments from a later, predefined age until the death of the beneficiary or employee.

### BACKGROUND OF THE INVENTION

Designing a retirement benefit plan that properly funds employees' retirement, yet is affordable for the sponsor, is difficult. Many people exhaust their plan benefits in retirement and many companies or municipalities may go bankrupt trying to fund their pension obligations.

Employees receive their retirement benefits in either a defined benefit plan or a defined contribution plan, or sometimes both. A defined contribution plan is a plan which provides a contribution by the employer but does not guarantee a benefit at retirement. Typically, these are called 401(k) plans and include contributions made by the employee. A defined benefit plan promises a guaranteed benefit to be paid in the future. The employer generally funds the full cost of this benefit and employee contributions are not typically seen. Defined benefit plans are also called pension plans.

The current state of underfunded public and private pension plans has been widely noted and it appears to be an important social policy to provide adequate retirement benefits for the average worker. Even for those plans currently properly funded, a complete reliance upon a defined benefit plan creates what many businesses consider to be an undue funding risk due to the inherent volatility in such an approach.

Conversely, a total reliance on defined contribution plans for a workforce is criticized by many because it requires sophisticated investment decisions. It is also difficult for participants to determine an optimal contribution rate and hedge longevity risk.

Thus, there is a need for a new retirement plan model which reduces the funding risk to employers, while simultaneously reducing or eliminating longevity risks to employees.

### DEFINITION OF TERMS

The following terms are used in the claims of the patent as filed and are intended to have their broadest plain and ordinary meaning consistent with the requirements of the law:

A “defined benefit input” is data comprising a specific formula or an amount that a retirement plan sponsor will contribute to a participant's retirement plan on a regular basis. The amounts will accrue into a benefit the plan sponsor promises the participant will receive upon the attainment of a specified age, such as age 85. The promised benefit will be predetermined by a formula based on such things as the employee's earnings history, age and years of service.

A “defined contribution input” is data comprising a specific formula or an amount that a retirement plan participant or a retirement plan sponsor or both will make to an individual account on a regular basis. The amounts will accumulate in the account over time to be withdrawn at a certain time, usually at retirement.

A “single income stream” is a flow of money designated by employer and employee election to be transferred at designated intervals to the participant so as to provide a series of payments beginning at a set time and lasting until a participant's death.

An “employer-sponsored retirement plan” is an investment and/or savings mechanism through which an employer provides an employee the ability to accumulate funds contributed by the employer, the employee or both.

A “beneficiary/participant request input” is data comprising a specific defined contribution amount that a retirement plan participant desires withdrawn from his or her account.

A “time phase shift” is a point in time in which a participant's payout changes from a defined contribution payout wherein he or she receives money from an account consisting of all of the individual and/or employer contributions and investment returns to a defined benefit payout wherein he or she receives a consistent payout at regular intervals until death.

A “risk shift profile” is an outline of possible outcomes that vary based on alternative time phase shifts and other factors. The risk shift profile is meant to determine the implications of alternative scenarios on an employer's retirement plan so as to determine the optimal arrangement.

A “participant” is an individual who is eligible to contribute to, and receive benefits from, an employer-sponsored retirement plan.

Where alternative meanings are possible, the broadest meaning is intended. All words used in the claims set forth below are intended for use in the normal, customary usage of grammar and the English language.

### SUMMARY OF THE INVENTION

The present invention relates to one or more of the following features, elements or combinations thereof.

The present invention encompasses a computer implemented method and system for a hybrid retirement system that combines the best of the defined benefit and defined contribution designs in a holistic approach. It produces a superior result compared to today's current designs, because it provides a retirement benefit plan for employees which is believed to reduce employer cost volatility by 80% or more, yet it can limit costs employees only 0.5% more of pay, and eliminates longevity risk for the oldest participants in the plan.

One disclosed embodiment of the present invention is directed to a computer implemented retirement system which includes a first server. This first server, which may be controlled or accessed by a retirement system plan manager or a company working with such a manager, and this server automatically generates retirement plan inputs for an desired income stream output, with this first server generating electronic requests for at least two electronic monetary inputs a given client's computer (e.g., a remote server or other computer accessible by an employee or the employee's company), the electronic monetary inputs including at least a defined benefit input and a defined contribution input. The system also includes at least a second server (e.g., a server managed by the employer company or a related financial institution) which receives the receiving an automated demand for benefit payments to a beneficiary corresponding to the desired income stream output generated by the first server, wherein the second server generates a signal for providing a single income stream including time phased defined benefit and defined contribution payout components.

The present invention further includes an embodiment involving a method for using a computer of the type used to administer an employer-sponsored retirement plan, including automatically calculating at least defined benefit and defined contribution components needed to fund a single income stream, generating at least one contribution request signal to a client computer to obtain defined benefit and defined contribution inputs so as to fund the components, automatically directing the formation of an annuity in response to the defined benefit contribution input, and automatically directing at least one third party server to generate the output of the single income stream. In this embodiment, the single income stream comprises time phased defined benefit and defined contribution payout components.

In alternative embodiments, the method and system of the present invention may be used to enable a company or an employee to adjust the plan inputs so as to adjust the time phase shift between defined benefit and defined contribution components, or to enable the employee or company to adjust the magnitude of one or both inputs as applicable to the plan, or to enable the automated selection of an appropriate annuity in response to the define benefit input for the plan. Further, another alternative embodiment enabled the first server to facility coordination between at least two separate third party servers so as to enable the “stacking” of defined benefit and defined contribution payouts such that the employee or beneficiary is proved a single continuous income stream throughout retirement.

Thus, it can be seen that one object of the disclosed invention is to provide a system and method for generating and administrating an automated retirement benefits plan comprising defined benefit and defined contribution components.

A further object of the present invention is to provide automated retirement benefits plan with a defined benefit component which reduces volatility risk to an employer.

Another object of the present invention is to provide automated retirement benefits plan with a defined benefit component which eliminates longevity risk to an employee.

Still another object of the present invention is to provide for the automated generation and coordination of a retirement benefit plan so as to generate a single retirement income stream.

It should be noted that not every embodiment of the claimed invention will accomplish each of the objects of the invention set forth above. For instance, certain claimed embodiments of the invention will not require the detection of malfunction events. In addition, further objects of the invention will become apparent based upon the summary of the invention, the detailed description of preferred embodiments, and as illustrated in the accompanying drawings. Such objects, features, and advantages of the present invention will become more apparent in light of the following detailed description of an example embodiment thereof, and as illustrated in the accompanying drawings.

### BRIEF DESCRIPTION OF THE DRAWINGS

FIG. 1 is a schematic figure of a computer system for generating and administrating a retirement benefit plan in accord with one preferred embodiment of the present invention;

FIG. 2 is a schematic figure of a computer system for generating, administrating and coordinating a retirement benefit plan between third party multiple servers in accord with one preferred embodiment of the present invention;

FIG. 3 is flow chart laying out a method establishing and administering a retirement benefits plan in accord with one embodiment of the present invention.

### DETAILED DESCRIPTION OF EMBODIMENTS OF THE INVENTION

A first example of the implementation of “stacked” hybrid retirement plan having both defined benefit and defined contribution portions in accord with a first preferred embodiment of the present invention may be explained as follows. The defined contribution plan only pays for the first twenty years of retirement. The employer then hedges the uncertain age at death by providing an equivalent annuity payable at age 85 until death. This is accomplished by creating a pension-like instrument that self-funds the annuity, in essence creating a “deferred to age 85” pension plan. The cost of this plan, prefunded by the employer using traditional actuarial techniques, will be shown to be nominal as compared to the current system pension design. Simply stated, in this example the hybrid design is a defined contribution plan for 20 years (providing benefits from age 65 to age 85), and a defined benefit plan from age 85 onward.

Theoretically, the system can be viewed using actuarial techniques. In order to do so, a derivation of the formula of a life annuity is necessary. The present value of an annuity payable beginning at age x using a discount factor i, and a probability of survival denoted kpx where k represents the time increment, and x equals age, is calculated using the formula:

$${\ddot{a}}_{x} = {\sum }_{k = 0}^{∞} \frac{1}{{( 1 + i )}^{k}} {}_{k}^{}{p}{}_{x}^{}$$

Furthermore, the life annuity can be split into two forms, the first of which represents a temporary annuity and the second of which represents a deferred annuity. For a 65 year old, the formula is:

\ddot{α}₆₅= [symbol] +₂₀₁\ddot{α}₆₅

The first term on the right hand side of the equation denotes the temporary benefit payable from age 65 to age 85. The second term on the right denotes a deferred to age 85 annuity. A computation for each term is calculated below using a 4.5% interest rate and the 2013 Applicable Mortality Table for lump sums on a unisex basis. The hybrid system is also apportioned below:

TABLE 1

| | Life annuity | Temporary annuity | Deferred annuity |
|---|---|---|---|
| | at 65 | from 65 to 85 | beginning at 85 |
| Present value | 12.6 | 11.4 | 1.2 |
| of $1 annual | | | |
| payment | | | |
| Percentage of | 100% | 90% | 10% |
| life annuity | | | |
| Hybrid system | Total Hybrid | DC portion | DB Portion |

It is important to note that the guaranteed portion of the hybrid system only comprises 10% of the cost in this example, thus a main factor in reduction in volatility for the employer. The DC portion, which is not guaranteed, represents the other 90% and shows the transfer of risk normally associated with a DB plan. This design change, however, also permits the employee to fund his or her defined contribution plan to a finite number of years (in this case, until age 85), thus reducing if not eliminating the risk of outliving one's retirement savings. That is, under this hybrid design, the participant would now base their distributions upon a fixed time horizon, rather than an unknown time horizon for the DC portion.

An application of the plan provided by the present invention as shown by the above example would be to redesign current traditional defined benefit plans from 100% insured benefit to a hybridized model that integrates both defined benefit and defined contribution components. For example, a traditional 1% of final average pay plan which produces a 6% of payroll employer cost would be converted to a 5.5% of pay profit sharing defined contribution plan and a 1% final average pay plan beginning at age 85 which would cost 0.5% of pay. The employer would not be paying any more than they do currently, and the volatility in the contribution and accounting costs would be reduced by over 80%. Retirees would be able to plan for retirement spending in a better fashion due to the knowledge that their 5.5% of pay defined contribution plan would only need to last 20 years.

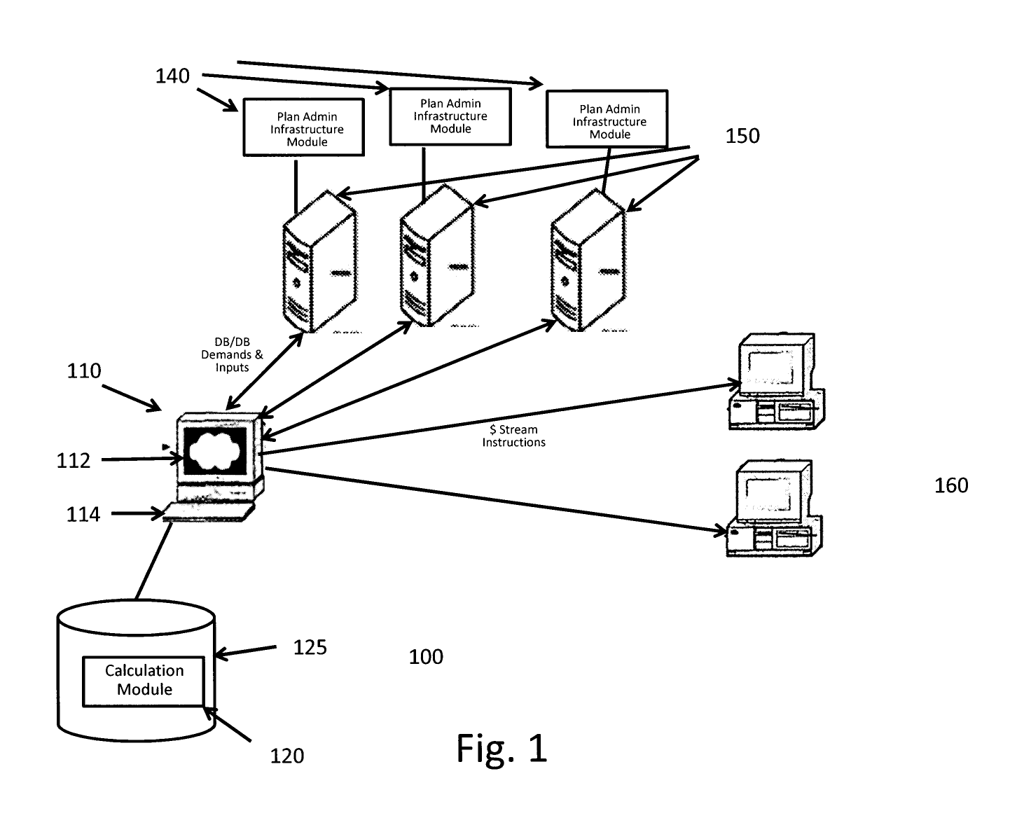

FIG. 1 illustrates an exemplary system 100 in which features and principles of the present invention may be implemented. System 100 may include a first or plan provider server 110, a calculation module 120, and one or more network servers 180.

Plan provider server 110 may be connected to any combination of components, devices, and mechanisms employed and/or maintained by a plan provider. The term “plan provider” refers to any entity that sponsors, provides, maintains, offers, and/or administers employee benefit plans. Examples of plan providers include actuarial firms, human resource departments, and outsourcing firms that provide services to the defined benefit pension market. Plan providers may also include corporations, firms, enterprises, small businesses, public/private organizations, governmental organizations, educational institutions, hospitals, service providers, and retail organizations.

Plan provider server 110 contains or is coupled to calculation module 120 contained on a memory 125. Calculation module 120 may be any computerized device containing algorithms (such as those shown above), or combinations of instructions operable to calculate benefits associated with both the defined contribution and defined benefit components of the plan. Calculation module 120 may also be configured to perform support functions associated with administering, maintaining, or distributing benefits of one or more DB plans. Consistent with principles of the present invention, calculation module 120 may be programmed or otherwise configured to adapt to plan changes, regulatory requirements, and/or other events. Calculation module 120 is most preferably implemented via one or more application software modules. In one example, such application software could reside in or be distributed among one or more dedicated data processing systems well known to those of skill in the art. For instance, one combination of components that could reside in or with the plan calculation server 110 includes a display device 112, an input device 114, a processor 116, and a memory 118. FIG. 1 does not identify separate components for processor 116 and memory 118, as those of skill in the art will understand that such components are contained with plan calculation server 110 in that example. Similar peripherals may likewise be provided with the other servers employed in the present invention.

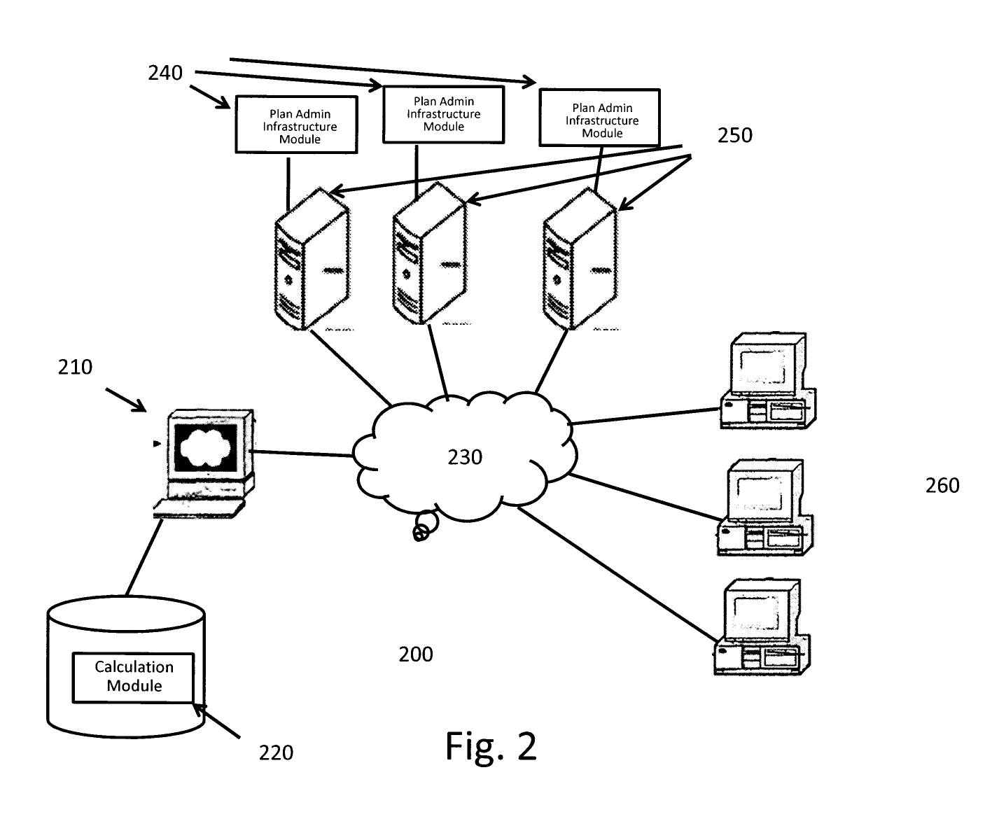

FIG. 2 shows another system 200 implemented consistent with the present invention in which the plan provider server 210 having a calculation module 220 is configured to interact with multiple plan administrators and related servicers. Plan provider server 210 and calculation module 220 is coupled to a network 230 (e.g., the internet). Also, a plurality of geographically dispersed plan administrator infrastructure modules 240 may be coupled via network plan administrator servers 250 (e.g., client computers corresponding to different plans for different employers) to network 230. Likewise, the system of this embodiment could be connected to multiple financial institution servers 260 via network 230 for receiving signals from the provider calculation module 220 and/or the plan administrator modules 240 to set up or distribute from annuities (e.g., in the case of defined benefit components) or accounts (in the case of defined contribution components) as appropriate for the implementation of a given employee's retirement benefit plan. In this fashion, a third party could maintain a single provider server 210 and calculation module that could interact with a plurality of plan providers and/or sponsors, as well as a plurality of financial institutions.

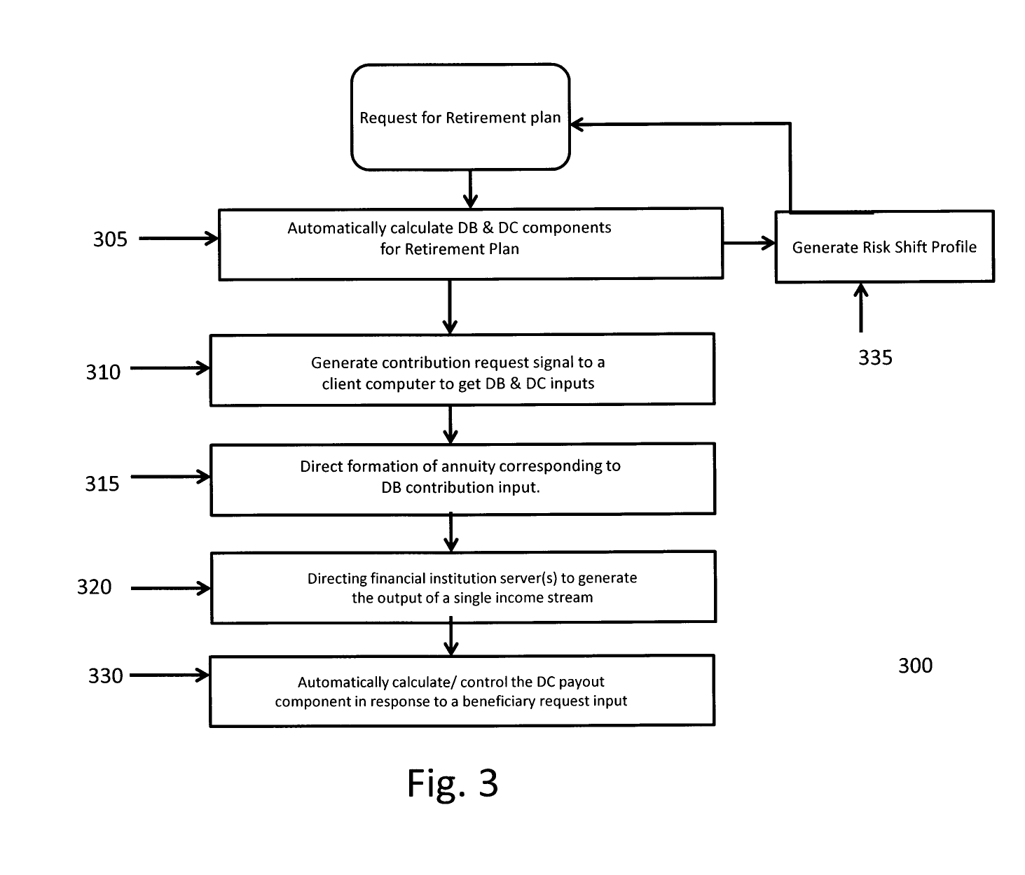

FIG. 3 shows a preferred method 300 of the present invention employing the computer components described above to generate, fund and administer retirement benefit plans in accordance with the present invention. A first step 305 involves automatically calculating at least defined benefit and defined contribution components so as to fund a single income stream (this may be implemented by calculation module 120). Next, a first server (e.g., provider server 210) can perform the step 310 of generating at least one contribution request signal to a client computer (e.g., the plan administrator servers 250) to obtain defined benefit and defined contribution inputs. With these inputs received, the provider server 210 can perform the step 315 of automatically direct (either by itself or with the administrator server 250 in conjunction with financial institution servers 260) the formation of an annuity in response to the defined benefit contribution input. This step may optionally include a feature using the calculation module 220 to automatically select the best or most appropriate annuity from a selection of annuities based upon the specific plan requirements and inputs. Finally, once the employee has reached retirement or otherwise becomes eligible for the distribution of benefits, the method involves the step 320 of automatically directing at least one server (e.g., the financial institution servers 260) so as to generate the output of the single income stream, the single income stream comprising time phased defined benefit and defined contribution payout components.

This process can optionally include the further step 325 (not shown) of automatically coordinating between two different third party servers (e.g., different financial institution servers 260), one of those servers controlling the defined benefit payout component, and a second one of the plurality of third party servers controlling the defined contribution payout component. Still another optional step 330 is the ability of either the provider server 210 and calculator module 220 to automatically calculate and control the defined contribution payout component in response to a beneficiary request input via a client computer (e.g. administrator server 240). Still another option for the calculator module 220 is the step 335 of automatically generating a risk shift profile for an employer in response to a user input (e.g., via administrator server 250). This step can optionally alter the risk shift profile in response to the employer's input adjusting either the time phase shift between defined benefit and defined contribution payout components and/or a magnitude shift in the desired defined benefit payout. In other words, in the event that a plan provider's risk appetite changes, the calculation module provides the ability to shift the transition point in time from defined contribution to defined benefit payout, or the amount of the defined benefit payout so as to provide the most desired, customized hybrid retirement plan.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the spirit and scope of the disclosure as defined by the appended claims.

What is claimed is:

1. A computer implemented retirement system comprising:
a) A first server for automatically generating electronic requests for at least two monetary inputs from at least one client computer, the monetary inputs including at least a defined benefit input and a defined contribution input; and
b) a second server receiving an automated demand for benefit payments to a beneficiary, wherein the second server generates a signal for a single income stream including time phased defined benefit and defined contribution payout components.

2. The computer implemented retirement system of claim 1, wherein the first server further generates a risk shift profile in response to the electronic requests for at least two monetary inputs.

3. The computer implemented retirement system of claim 2, wherein the risk shift profile generated by the first server may be recalculated and modified in response to an input from a client computer.

4. The computer implemented retirement system of claim 3, wherein the risk shift profile generated changes in response to a modification of the magnitude of the defined benefit input.

5. The computer implemented retirement system of claim 3, wherein the risk shift profile generated changes in response to a modification in the time phase shift between defined benefit and defined contribution payout components.

6. The computer implemented retirement system of claim 1, wherein the second server is a plan administrator server.

7. A computer-implemented method for use with a computer of the type used to administer an employer-sponsored retirement plan, comprising the steps of:
a) automatically calculating at least defined benefit and defined contribution components so as to fund a single income stream;
b) generating at least one contribution request signal to a client computer to obtain defined benefit and defined contribution inputs;
c) automatically directing the formation of an annuity in response to the defined benefit contribution input; and
d) automatically directing at least one 3^{rd} party server so as to generate the output of the single income stream, the single income stream comprising time phased defined benefit and defined contribution payout components.

8. The computer implemented method of claim 7, further comprising the step of automatically coordinating between a plurality of third party servers, a first one of the plurality of third party servers controlling the defined benefit payout component, and a second one of the plurality of third party servers controlling the defined contribution payout component.

9. The computer implemented method of claim 7, further comprising the step of automatically calculating and controlling the defined contribution payout component in response to a beneficiary request input.

10. The computer implemented method of claim 7, wherein the step of automatically directing the formation of an annuity comprises the automated selection of an annuity provider from a plurality of annuity providers.

11. The computer implemented method of claim 7, further comprising the step of automatically generating a risk shift profile for a client in response to a user input adjusting the time phase shift between defined benefit and defined contribution payout components.

12. The computer implemented method of claim 7, further comprising the step of automatically generating a risk shift profile for a client in response to a user input adjusting a magnitude shift of the defined benefit input.
